(19) United States
(12) Patent Application Publication
(10) Pub. No.: US 2017/0175860 A1
(43) Pub. Date: Jun. 22, 2017

(54) BEARING COMPONENT

(71) Applicant: SCHAEFFLER TECHNOLOGIES AG & CO. KG, Herzogenaurach (DE)

(72) Inventor: Philippe Ott, Uttenhoffen (FR)

(73) Assignee: Schaeffler Technologies AG & Co. KG, Herzogenaurach (DE)

(21) Appl. No.: 15/324,409

(22) PCT Filed: Mar. 12, 2015
(86) PCT No.: PCT/DE2015/200147

§ 371 Date: Jan. 6, 2017

(30) Foreign Application Priority Data
Jul. 10, 2014 (DE) 10 2014 213 436.6

(51) Int. Cl. F16H 25/22

(52) U.S. Cl. CPC F16H 25/2204; F16D 28/00

(57) ABSTRACT

Bearing component having an outer raceway, an inner raceway and balls accommodated therebetween; one raceway has an ogival profile while the other raceway has a spherical profile.

### BACKGROUND

The invention relates to a bearing component with an outer raceway and an inner raceway and balls held in-between these raceways.

For bearing components, different geometries are used for the raceways. It is known to produce the spherical raceway for a ball screw both on the spindle and also on the ball thread nut with a roundly tapered (ogival) profile. Similarly, for an axial ball bearing (four-point bearing), the inner ring and the outer ring can also be equipped with a roundly tapered profile.

For a raceway that has a roundly tapered profile, under some circumstances an undesired three-point contact can occur that has negative effects on the rolling of the roller bearing.

On the other hand, for a radial ball bearing it is usual to provide an inner ring and an outer ring with a continuous radius, that is, with a spherical profile. The inner ring and outer ring are here adapted to the diameter of the balls.

Both structures, however, also have disadvantages. Axial ball bearings (four-point bearing) are suitable for receiving a torque, but their production is difficult because tight tolerances must be observed. Because more dimensions must be inspected in a roundly tapered profile in comparison to a spherical profile, the production is complicated.

From document CH 356 319, a ball bearing is known whose raceways have different contact points to the balls.

### SUMMARY

The invention is based on the object of providing a bearing component that is suitable for higher loads for the same installation space.

To achieve this objective, for a bearing component of the type specified above, it is provided according to the invention that one raceway has a roundly tapered profile and the other raceway has a spherical profile.

The bearing component according to the invention combines the advantages of a roundly tapered profile with those of a continuous profile. However, because a roundly tapered profile is provided for one raceway, the production and measurement expense is considerably reduced in comparison with a bearing component having two raceways with roundly tapered profiles. One prerequisite, however, is that axial play is permissible during operation for a bearing component according to the invention.

A preferred refinement of the bearing component according to the invention provides that the outer raceway has the roundly tapered profile and the inner raceway has the spherical profile. This construction produces a tighter contact to the inner ring, which can increase the load to be received by the bearing component. Accordingly, the bearing component according to the invention can receive and transmit a higher load for the same installation space.

A first construction of the bearing component according to the invention provides that it is constructed as a ball bearing, wherein the outer raceway is constructed on an outer ring and the inner raceway is constructed on an inner ring. The bearing component according to the invention is thus a special ball bearing in which preferably the outer ring has the roundly tapered profile and the inner ring has the spherical profile.

According to a second, alternative construction of the invention, the bearing component according to the invention can be constructed as a ball screw, wherein the outer raceway is constructed on a ball thread nut and the inner raceway is constructed on a threaded spindle. The bearing component constructed as the threaded spindle is also distinguished by a small installation space and a large load that can be received.

The invention also relates to an electric central release bearing that has a bearing component of the described type.

### BRIEF DESCRIPTION OF THE DRAWINGS

The invention is explained below using an embodiment with reference to the drawings. The drawings are schematic representations and show:

FIG. 1 a detail of a conventional bearing component with roundly tapered profile, and

FIG. 2 a detail of a bearing component according to the invention.

### DETAILED DESCRIPTION OF THE PREFERRED EMBODIMENTS

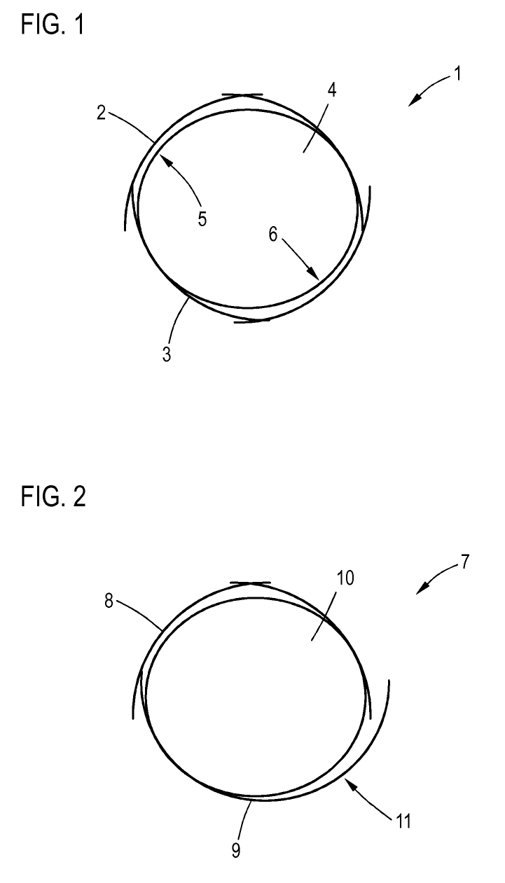

FIG. 1 shows a detail of a conventional bearing component 1 with an outer ring 2, an inner ring 3, and balls 4 held in-between these raceways. In FIG. 1, it can be seen that the raceways of the outer ring 2 and the inner ring 3 are each constructed as roundly tapered profiles. In FIG. 1, arrows 5, 6 are drawn at two opposite positions at which close production tolerances are to be maintained, in order to prevent contact between the ball 4 and the roundly tapered profile of the bearing ring at this position.

Accordingly, FIG. 2 shows a bearing component 7 with an outer ring 8 that has a roundly tapered profile and an inner ring 9 that has a continuous profile. The bearing component 7 thus has the outer ring 8, the inner ring 9, and balls 10 arranged in-between these raceways. At the position marked by the arrow 11 in FIG. 2, the distance between the inner ring 9 and the ball 10 is greater in comparison to the conventional bearing component 1 of FIG. 1. Therefore, even with the consideration of tolerances, there can be no undesired point contact between the inner ring 9 and the ball 10. Because tighter contact is possible, the bearing component 7 can be constructed in an especially compact way and it is distinguished by a longer service life in comparison with a conventional bearing component.

The functional principle shown in FIG. 2 can also be transferred to a bearing component constructed as a ball screw. Here, the outer raceway is constructed on a ball thread nut and has a roundly tapered profile; the inner raceway is constructed on a threaded spindle and has a spherical profile, that is, a continuous profile.

The bearing component described with reference to FIG. 2 is especially well suited for use in an electric central release bearing for a coupling.

### LIST OF REFERENCE NUMBERS

1 Bearing component

2 Outer ring

3 Inner ring

4 Ball

5 Arrow

6 Arrow

7 Bearing component

8 Outer ring

9 Inner ring

10 Ball

11 Arrow

1. A ball screw, comprising an outer raceway constructed on a ball thread nut and an inner raceway constructed on a threaded spindle, and balls held in-between said raceways, one of the raceways has a roundly tapered profile and another of the raceways has a spherical profile.

2. The bearing component according to claim 1, wherein the outer raceway has the roundly tapered profile and the inner raceway has the spherical profile.

3. The bearing component according to claim 1, wherein it is constructed as a spherical bearing, wherein the outer raceway is constructed on an outer ring and the inner raceway is constructed on an inner ring.

4. (canceled)

5. An electric central release bearing comprising the bearing component according to claim 1.
